(19) United States
(12) Patent Application Publication
(10) Pub. No.: US 2025/0211164 A1
(43) Pub. Date: Jun. 26, 2025

(54) SOLAR OUTDOOR DECORATIVE LIGHT GROUP AND POWER SUPPLY EXTENSION LINE

(71) Applicant: SHITING HE, Zhumadian (CN)

(72) Inventor: SHITING HE, Zhumadian (CN)

(21) Appl. No.: 18/396,005

(22) Filed: Dec. 26, 2023

(51) Int. Cl. H02S 40/34; F21S 9/03; F21V 21/008; F21V 23/06; H02S 20/32; H02S 50/00

(52) U.S. Cl. CPC H02S 40/34; F21S 9/032; F21V 21/008; F21V 23/06; H02S 20/32; H02S 50/00

(57) ABSTRACT

The present disclosure discloses a power supply extension line including a junction box. The junction box is fixedly connected with a conductive sheet providing with a bus. An end of the bus away from the junction box is provided with a triangular plug, an end of the conductive sheet away from the bus is provided with a branching line assembly, the branching line assembly respectively includes a branching line A, a branching line B and a branching line C at an end of the conductive sheet away from the bus, ends of the branching line A, the branching line B, and the branching line C away from the conductive sheet are respectively provided with a high-and-low voltage connector, a female plug, and a multifunctional adapter. The present application solves a problem of insufficient photovoltaic energy supply when connecting two or more solar outdoor decorative lamp groups.

### TECHNICAL FIELD

The present disclosure relates to the field of light string connection technologies, and in particular, to a solar outdoor decorative light group and power supply extension line.

### BACKGROUND

With a continuous development of the lighting industry and technological progress, people's requirements for lighting string lights are becoming more and more diverse. The traditional connection method of one plug connector for one light is changing to one plug connector for multiple lights. Due to the need for lighting fixtures to emit light for a long time to achieve decorative effects and the high-power consumption of multiple lighting fixtures, in order to provide electricity to lighting fixtures while saving electricity, a researcher has developed a solar powered lamp group.

The existing solar outdoor decorative light groups are mostly composed of a single solar power supply component and a light string component. By installing outdoor photovoltaic panels to provide power to the light groups, the structure is relatively simple. In order to save photovoltaic power consumption, the existing solar outdoor decorative light groups are commonly used to connect a single group of light groups.

When connecting two or more light groups, multiple light groups not only consume more energy, but also rely solely on a single solar assembly for power supply, rendering it difficult to meet the long-term lighting needs of the light group. It is also necessary to use a one-to-many switching device for the switching of multiple light groups, and the switching device generally does not have a conversion function of high voltage to low voltage, resulting in poor overall safety of the light group.

### SUMMARY

A purpose of the present disclosure is to provide a solar outdoor decorative lamp group and a power supply extension line to solve a problem proposed in the background technology.

In order to achieve the above purpose, the present disclosure provides the following technical solution: a power supply extension line, including a junction box, where a conductive sheet is fixedly connected in the junction box, an end of the conductive sheet is provided with a bus, an end of the bus away from the junction box is provided with a triangular plug, an end of the conductive sheet away from the bus is provided with a branching line assembly.

In an embodiment of the present disclosure, the branching line assembly include a branching line A, a branching line B, and a branching line C located at an end of the conductive sheet away from the bus, respectively; ends of the branching lines A, the branching line B, and the branching line C away from the conductive sheet are respectively provided with a high-and-low voltage connector, a female plug, and a multifunctional adapter.

In an embodiment of the present disclosure, the high-and-low voltage connector is a conversion connector form high voltage to low voltage.

In an embodiment of the present disclosure, the bus, the branching line A, the branching line B, and the branching line C are all welded and connected to the conductive sheet.

In an embodiment of the present disclosure, the bus, the branching line A, the branching line B, the branching line C, and the junction box are integrated, the branching line A, the branching line B, and the branching line C are all provided with a current division structure.

A solar outdoor decorative lamp group with the power supply line, including an energy supply mechanism, a control mechanism, a connection mechanism, and an execution mechanism, the energy supply mechanism includes a photovoltaic panel and a battery that continuously provide power to the decorative lamp group, the battery is provided with a topological charging interface;

the connection mechanism includes a main connection line and one or more branch connection lines, one end of the main connection line is connected to the control mechanism, and the other end of the main connection line is connected to a corresponding branch connection line through an extension assembly, the branch connection line is divided into several groups, the branch connection lines in each group are connected in pairs through a T-shaped interface, an end of the branch connection line away from the main connection line is provided with a waterproof plug or an extension joint.

In an embodiment of the present disclosure, the control mechanism includes a triggering mechanism and an electronic control part for turning on the photovoltaic panel and the battery, after the triggering mechanism is triggered, the electronic control part controls the execution mechanism to start or close, and the execution mechanism includes multiple light-emitting elements, a connection end of each light-emitting element is provided with an interface that is compatible with an unconnected end of the T-shaped interface, the triggering mechanism includes a proximity physical switch, a voice controller, and a remote control switch.

In an embodiment of the present disclosure the light-emitting element is a light bulb or a light string.

In an embodiment of the present disclosure, the energy supply mechanism is further provided with a light automatic tracking module to keep the photovoltaic panel rotating in the same direction and frequency as the sun.

In an embodiment of the present disclosure, the control mechanism further includes a temperature sensor and a humidity senso; when the temperature sensor determines that a temperature exceeds a reasonable range, the electric control part controls the execution mechanism to turn off, when the humidity sensor determines that a humidity exceeds a reasonable range, the electric control part controls the execution mechanism to close.

The beneficial effects of the present disclosure are as follows:
1. The present disclosure provides power to the lamp system by setting up an energy supply mechanism, which is coordinated by a photovoltaic panel and a battery. The power can be generated through the photovoltaic panel while also being supplied through the battery on rainy days or nights to provide continuous light and improve energy efficiency. Multiple triggering mechanisms are provided with, including a physical switch, a voice controller, and a remote-control switch, to cooperate with the electrical control part to start or stop the execution mechanism, improving a level of intelligence by turning off the light group through the physical switch when not in use, and reducing energy consumption.
2. The present disclosure can perceive temperature and humidity values in real time by providing with temperature and humidity sensors. By setting up a reasonable range threshold for temperature and humidity, when the threshold is reached, the electric control part will cooperate to shut down the execution mechanism, protect the entire lamp group system, and improve safety and controllability.
3. The present disclosure improves the flexibility and applicability of use by providing with an extension component, which includes a high-and-low voltage connector, a female plug, and a multifunctional adapter on the branching line A, the branching line B, and the branching line C.
4. The present disclosure divides the input current into several output currents based on its set values by setting current dividers in the branching line A, the branching line B, and the branching line C, thereby effectively managing a distribution of current and avoiding problems such as uneven current distribution or overload.

### BRIEF DESCRIPTION OF DRAWINGS

FIG. 1 is an overall architecture of the present disclosure.

FIG. 2 is a schematic diagram of an extension assembly of the present disclosure.

FIG. 3 is a cross-sectional schematic diagram of the present disclosure used to display an internal structure of a junction box.

FIG. 4 is a block diagram of the present disclosure used to demonstrate a control mechanism.

Reference number: 1. Energy supply mechanism; 2. Control mechanism; 21. Proximity physical switch; 22. Voice controller; 23. Remote-control switch; 24. Temperature sensor; 25. Humidity sensor; 3. Connection mechanism; 31. Main connection line; 32. Connection line; 33. T-shaped interface; 34. Waterproof plug; 35. Extension joint; 4. Execution mechanism; 41. Light-emitting element; 42. Interface; 5. Junction box; 51. Bus; 511. Triangle plug; 52. Branching line A; 521. High-and-low voltage connector; 53. Branching line B; 531. Female plug; 54. Branching line C; 541. Multifunctional adapter; 55. Conductive sheet.

### DESCRIPTION OF EMBODIMENTS

The following will provide a clear and complete description of the technical solution in the embodiments of the present disclosure, in combination with the drawings. Obviously, the described embodiments are only a part of the embodiments of the present disclosure, not all of them. Based on the embodiments in the present disclosure, all other embodiments obtained by ordinary technicians in the art without creative work fall within the protection scope of the present disclosure.

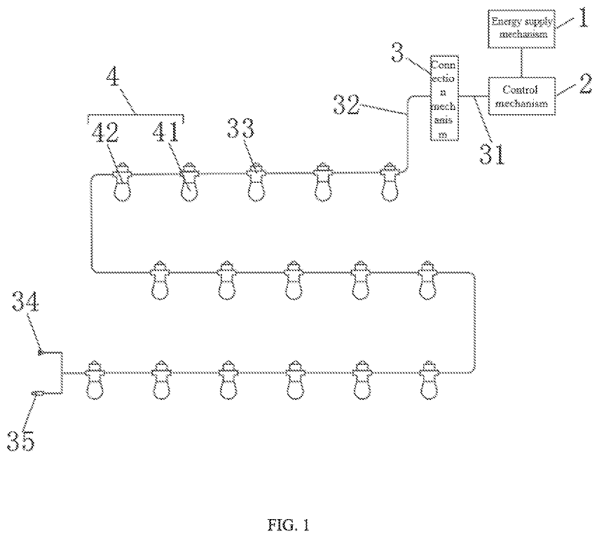

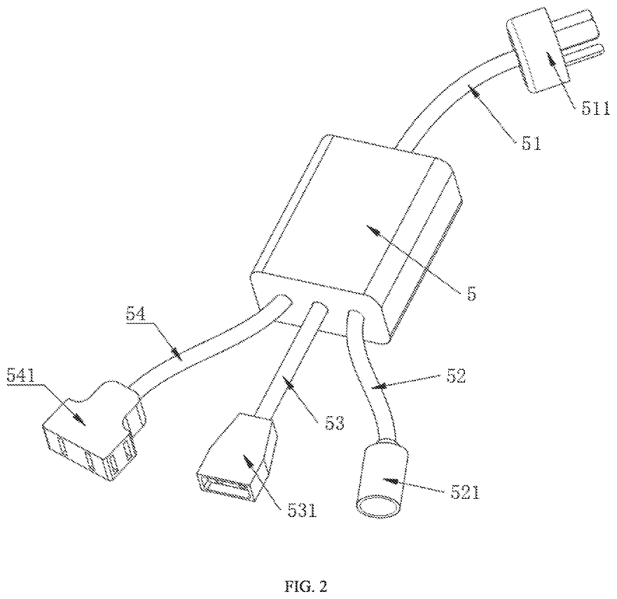

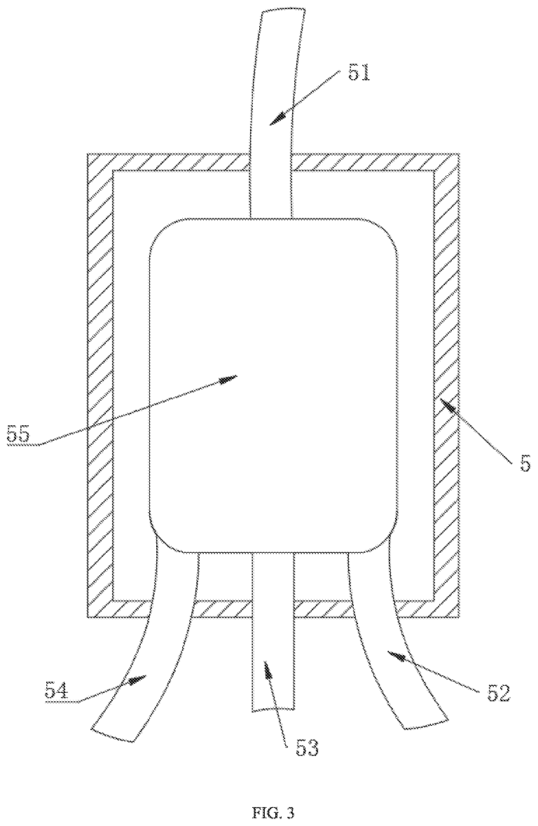

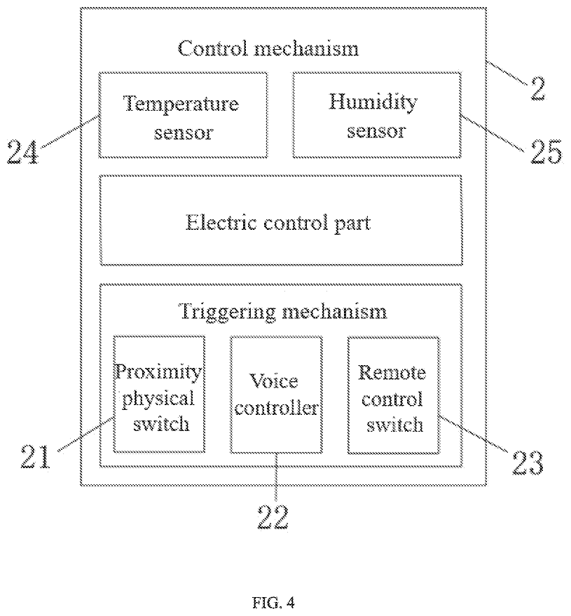

As shown in FIGS. 1 to 4, an embodiment of the present disclosure provide a power supply extension line including a junction box 5, which is fixedly connected with a conductive sheet 55. An end of the conductive sheet 55 is provided with a bus 51, a triangular plug 511 is provided at an end of the bus 51 away from the junction box 5. A branching assembly is provided at an end of the conductive sheet 55 away from the bus 51.

Furthermore, in one embodiment, the branching assembly includes a branching line A 52, a branching line B 53, and a branching line C 54 located at an end of the conductive sheet 55 away from the bus 51. The branching line A 52, the branching line B 53, and the branching line C 54 are respectively provided with a high-and-low voltage connector 521, a female plug 531, and a multifunctional adapter 541 at an end away from the conductive sheet 55.

The high-and-low voltage connector 521 is a conversion connector from high voltage to low voltage, which facilitates the conversion of high voltage to low voltage and ensures safety when connecting the lamp group.

The bus 51 is provided at an end of the junction box 5, a length of the bus 51 is selected according to needs for adaptation to different usage scenarios. A triangular plug 511 is provided at an end of the bus 51, which is suitable for, connecting a socket. On the other end of the junction box 5, the branching line A 52, the branching line B 53, and the branching line C 54 are provided, and ends of the branching line A 52, the branching line B 53 and the branching line C 54 are respectively provided with a high-and-low voltage connector 521, a female plug 531, and a multifunctional adapter 541, which are used to convert high voltage to low voltage and adapt to various plugs, improve applicability and facilitate the transfer of various types of lamp groups.

Where, the bus 51, the branching line A 52, the branching line B 53, and the branching line C 54 are all welded and connected to the conductive sheet 55, and the stability of the bus 51, the branching line A 52, the branching line B 53, and the branching line C 54 is ensured through a way of welding fixation.

Furthermore, the bus 51, the branching line A 52, the branching line B 53, the branching line C 54, and the junction box 5 are integrated, this enhances a waterproof performance and stability. The branching line A 52, the branching line B 53, and the branching line C 54 are all provided with a current division structure. The current division structure is achieved by providing with current dividers in the branching line A 52, the branching line B 53, and the branching line C 54, which can divide input current into several output currents according to a set value, effectively managing a distribution of current, avoiding a problem such as uneven current distribution or overload.

A solar outdoor decorative light group includes an energy supply mechanism 1, a control mechanism 2, a connection mechanism 3, and an execution mechanism 4. The energy supply mechanism 1 includes a photovoltaic panel and a battery that continuously provide power to the decorative light group. The battery is provided with a topological charging interface for charging the battery. The photovoltaic panel is a fixed or movable photovoltaic panel, which is easy to adjust its position to obtain the best lighting effect, the battery is used in scenarios where the power generated by photovoltaic panel is insufficient or the panel cannot be used, such as cloudy, rainy weather, and at night, to provide continuous power supply to the lamp group.

The connection mechanism 3 includes a main connection line 31 and one or more branch connection lines 32. An end of the main connection line 31 is connected to the control mechanism 2, and the other end of the main connection line 31 is connected to a corresponding branch connection line 32 through an extension component. The branch connection line 32 is divided into multiple groups, and branch connection lines 32 in each group are connected in pairs through a T-shaped interface 33. An end of the branch connection line 32 away from the main connection line 31 is provided with a waterproof plug 34 or an extension joint 35, the extension joint 35 is used to extend the lamp group when it is convenient for use, and to plug the waterproof plug 34 for waterproofing when not in use.

It should be noted that bus 51 is connected to the main connection line 31 through a triangular plug 511, and the branching assembly is connected to a corresponding branch connection line 32.

The control mechanism 2 includes a triggering mechanism and an electrical control part for turning on the photovoltaic panel and the battery. After the triggering mechanism is triggered, the electrical control part controls the execution mechanism 4 to start or close. The execution mechanism 4 includes multiple light-emitting elements 41, a connection end of each light-emitting element 41 is provided with an interface 42 that is compatible with an unconnected end of the T-shaped interface 33. The triggering mechanism includes a proximity physical switch 21, a voice controller 22, and a remote-control switch 23.

The light-emitting element 41 is a light bulb or a light string, and the light bulb can have different shaped structures, or other light-emitting bodies with different shaped structures can be provided.

The energy supply mechanism 1 is further provided with a light automatic tracking module, which allows the photovoltaic panel to rotate in the same direction and frequency as the sun. The light automatic tracking module includes a photosensitive sensor installed on the photovoltaic panel, and is driven by a motor to form a movable mechanism, so that the photovoltaic panel can rotate in the same frequency as a motion trajectory of the sun under sufficient light, thereby improving a photovoltaic conversion efficiency of the photovoltaic panel.

The control mechanism 2 further includes a temperature sensor 24 and a humidity sensor 25. When the temperature sensor 24 determines that a temperature exceeds a reasonable range, the electrical control part controls the execution mechanism 4 to close. When the humidity sensor 25 determines that a humidity exceeds a reasonable range, the electrical control part controls the execution mechanism 4 to close. Set thresholds of temperature sensor 24 and humidity sensor 25 are selected according to different environments.

### Working Principle:

At one end of the junction box 5, the branching line A 52, the branching line B 53, and the branching line C 54 are respectively installed. The high-and-low voltage connector 521, the female plug 531, and the multifunctional adapter 541 are installed at an end to improve a flexibility of a connection and facilitate a matching of different interface light groups. The bus 51, the branching line A 52, the branching line B 53, and the branching line C 54 are respectively welded to the conductive sheet 55 to improve stability.

The entire lamp group is powered by the energy supply mechanism 1, including a photovoltaic panel and a battery. Under a normal condition, power is generated by the photovoltaic panel during the day, and the entire lamp group is powered by the battery at night. On rainy or cloudy days or when the photovoltaic power is insufficient at night, the lamp group is powered by the battery. By providing with the main connection line 31 and several connection lines 32, combined with an extension assembly, the energy supply mechanism 1 can be connected to multiple lamp groups simultaneously, and with a coordination of temperature sensor 24 and humidity sensor 25, the temperature and humidity thresholds are adjusted according to the working environment and conditions of the entire lamp group system. When the temperature and humidity reach the threshold, the electric control part cooperates to turn off the execution mechanism 4 to ensure the stability of the operation of the lamp group. Through a physical switch, a voice controller 22, and a remote-control switch 23, the entire lamp group can be controlled in multiple ways, the physical switch can directly turn on or off the system, the voice controller 22 can be controlled through voice at close range, and the remote control switch 23 can be remotely controlled to turn on or off the light group.

It should be noted that in this description, relational terms such as first and second are only used to distinguish one entity or operation from another entity or operation, and do not necessarily require or imply any actual relationship or order between these entities or operations. Moreover, the terms “including”, “comprising”, or any other variation thereof are intended to encompass non-exclusive inclusion, such that a process, method, item, or device that includes a series of elements not only includes those elements, but also includes other elements that are not explicitly listed, or also includes elements inherent to such process, method, item, or device.

Although embodiments of the present disclosure have been shown and described, it can be understood by those skilled in the art that multiple variations, modifications, substitutions, and variations can be made to these embodiments without departing from the principles and spirit of the present disclosure. The scope of the present disclosure is limited by the claims and their equivalents.

What is claimed is:

1. A power supply extension line, comprising a junction box (5), wherein a conductive sheet (55) is fixedly connected in the junction box (5), an end of the conductive sheet (55) is provided with a bus (51), an end of the bus (51) away from the junction box (5) is provided with a triangular plug (511), an end of the conductive sheet (55) away from the bus (51) is provided with a branching line assembly.

2. The power supply extension line according to claim 1, wherein the branching line assembly comprises a branching line A (52), a branching line B (53), and a branching line C (54) located at an end of the conductive sheet (55) away from the bus (51), respectively; ends of the branching line A (52), the branching line B (53), and the branching line C (54) away from the conductive sheet (55) are respectively provided with a high-and-low voltage connector (521), a female plug (531) and a multifunctional adapter (541).

3. The power supply extension line according to claim 2, wherein the high-and-low voltage connector (521) is a conversion connector from high voltage to low voltage.

4. The power supply extension line according to claim 1, wherein the bus (51), the branching line A (52), the branching line B (53), and the branching line C (54) are all welded and connected to the conductive sheet (55).

5. The power supply extension line according to claim 2, wherein the bus (51), the branching line A (52), the branching line B (53), and the branching line C (54) are all welded and connected to the conductive sheet (55).

6. The power supply extension line according to claim 1, wherein the bus (51), the branching line A (52), the branching line B (53), the branching line C (54), the junction box (5) are integrated, the branching line A (52), the branching line B (53), and the branching line C (54) are all provided with a current division structure.

7. The power supply extension line according to claim 2, wherein the bus (51), the branching line A (52), the branching line B (53), the branching line C (54), the junction box (5) are integrated, the branching line A (52), the branching line B (53), and the branching line C (54) are all provided with a current division structure.

8. The power supply extension line according to claim 3, wherein the bus (51), the branching line A (52), the branching line B (53), the branching line C (54), the junction box (5) are integrated, the branching line A (52), the branching line B (53), and the branching line C (54) are all provided with a current division structure.

9. The power supply extension line according to claim 4, wherein the bus (51), the branching line A (52), the branching line B (53), the branching line C (54), the junction box (5) are integrated, the branching line A (52), the branching line B (53), and the branching line C (54) are all provided with a current division structure.

10. A solar outdoor decorative lamp group with the power supply line according to claim 1, comprising an energy supply mechanism (1), a control mechanism (2), a connection mechanism (3), and an execution mechanism (4), wherein the energy supply mechanism (1) comprises a photovoltaic panel and a battery that continuously provide power to the decorative lamp group, wherein the battery is provided with a topological charging interface;
the connection mechanism (3) comprises a main connection line (31) and one or more branch connection lines (32), one end of the main connection line (31) is connected to the control mechanism (2), and the other end of the main connection line (31) is connected to a corresponding branch connection line (32) through an extension assembly, the branch connection line (32) is divided into several groups, the branch connection lines (32) in each group are connected in pairs through a T-shaped interface (33), an end of the branch connection line (32) away from the main connection line (31) is provided with a waterproof plug (34) or an extension joint (35).

11. The solar outdoor decorative lamp group according to claim 10, wherein the control mechanism (2) comprises a triggering mechanism and an electric control part for turning on the photovoltaic panel and the battery; after the triggering mechanism is triggered, the electric control part controls the execution mechanism (4) to start or close, and the execution mechanism (4) comprises multiple light-emitting elements (41), a connection end of each light-emitting element (41) is provided with an interface (42) that is compatible with an unconnected end of the T-shaped interface (33), the triggering mechanism comprises a proximity physical switch (21), a voice controller (22), and a remote control switch (23).

12. The solar outdoor decorative lamp group according to claim 11, wherein the light-emitting element (41) is a light bulb or a light string.

13. The solar outdoor decorative lamp group according to claim 10, wherein the energy supply mechanism (1) is further provided with a light automatic tracking module to keep the photovoltaic panel rotating in the same direction and frequency as the sun.

14. The solar outdoor decorative lamp group according to claim 10, wherein the control mechanism (2) further comprises a temperature sensor (24) and a humidity sensor (25); when the temperature sensor (24) determines that a temperature exceeds a reasonable range, the electric control part controls the execution mechanism (4) to turn off, when the humidity sensor (25) determines that a humidity exceeds a reasonable range, the electric control part controls the execution mechanism (4) to close.
